(19) United States
(12) Patent Application Publication
(10) Pub. No.: US 2010/0031173 A1
(43) Pub. Date: Feb. 4, 2010

(54) Business Card Scanner

(75) Inventor: Ozel Djemal, Greystanes (AU)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ondis Pty Ltd., Greystanes (AU)

(21) Appl. No.: 12/307,168

(22) PCT Filed: Mar. 27, 2007
(86) PCT No.: PCT/AU2007/000383

§ 371 Date: Sep. 22, 2009

(30) Foreign Application Priority Data
Jul. 3, 2006 (AU) 2006903571

(51) Int. Cl. G06F 3/048

(52) U.S. Cl. 715/764

(57) ABSTRACT

An electronic communications device (100) for use in voice, text and graphics wireless communications over a communications network (320), is disclosed. The device (100) integrates a business card scanner therein. The device (100) comprises a casing (101) comprising therein a scanning unit (109). The casing (101) further comprises therein wireless communications means (316) for performing the wireless communications. The device (100) comprises a receptacle (105) formed from the casing (101) for receiving the business card (201) to allow the business card (201) to be scanned by the scanning unit (109). The device (100) a display (314) for displaying an image of the business card (201) scanned by the scanning unit (109).

### FIELD OF THE INVENTION

The present invention relates to an electronic communications device integrating a business card scanner.

### BACKGROUND

Business cards are well known. Traditionally, business cards are manufactured out of paper or cardboard with information (e.g., a name, photo, address, telephone number, fax number, E-mail address, etc) printed thereon. Such business cards are routinely exchanged by business people in order to promote their business and develop business contacts. However, the proliferation of business cards distributed over time means that the information printed on business cards is often poorly utilized.

Traditionally, collected business cards have been stored in hard copy form in an indexed file or folder. However, again, the proliferation of business cards means that such files or folders often become unwieldy and difficult to use. Further, such files or folders make it difficult to sort the business cards stored therein.

In view of the disadvantages of the traditional methods of collecting and storing business cards, business card scanners have been developed. Business card scanners utilize any suitable technology or any combination of technologies, such as optical technologies, magnetic technologies or the like, to convert graphical and textual information printed on business cards into electrical signals which may be processed and stored in a computer memory.

Such business card scanners have traditionally been standalone devices, which are often not convenient for a user to carry and use, and merely add to the number of electronic devices (e.g., personal digital assistant (PDA), mobile telephone, laptop, etc) that the user must carry. As a result, there have been some attempts to integrate a business card scanner with other devices. For example, U.S. Pat. No. 6,789,734 (Tu) discloses a personal digital assistant (PDA) electrical charger integrating a business card scanner. However, in this instance, a user is still required to carry the electrical charger together with their PDA if the user wishes to scan business cards regularly. Further, images of business cards scanned with the electrical charger need to be downloaded to a computer or similar device in order to be stored, viewed or even distributed.

Some known mobile camera telephones may be used to capture an image of documents, such as business cards, using the camera on the telephone. However, the images captured with such telephones are often distorted and of poor quality. Further, it is difficult for a user using such mobile camera telephones to control the size of the document (e.g., the business card) within the captured image. As a result, the documents in the captured images often cannot be read.

Thus, a need clearly exists for a device which enables business cards to be collected, scanned, stored, used and distributed more efficiently.

### SUMMARY

It is an object of the present invention to substantially overcome, or at least ameliorate, one or more disadvantages of existing arrangements.

According to one aspect of the present invention there is provided an electronic communications device for use in voice, text and graphics wireless communications over a communications network, said device integrating a business card scanner, said device comprising:

a casing comprising therein a scanning unit, said casing further comprising therein wireless communications means for performing said wireless communications;

a receptacle formed from said casing for receiving said business card to allow said business card to be scanned by the scanning unit; and

a display for displaying an image of the business card scanned by the scanning unit.

According to another aspect of the present invention there is provided a display for scanning a document, said display comprising a plurality of light sensitive diodes interleaved with a plurality of light emitting diodes.

According to still another aspect of the present invention there is provided an electronic communications device for use in voice, text and graphics wireless communications over a communications network, said device comprising:

a casing comprising therein one or more image capture devices, said casing further comprising therein wireless communications means for performing said wireless communications;

a window integrally formed with said casing for providing access to said image capture devices to allow an image of a business card to be captured when said business card is placed against said window; and

a display for displaying the image of the business card captured by the image capture devices, wherein said window is substantially of the same size as said business card.

According to still another aspect of the present invention there is provided an electronic communications device for use in capturing an image of a business card, said device comprising a display for displaying said image of said business card, said display comprising one or more image capture devices for capturing said image of said business card when said business card is placed against said display.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1A shows a detailed exploded view of an electronic communications device comprising a casing and a communications module, according to one embodiment of the present invention;

FIG. 1B shows a bottom view of a bottom section of the casing of FIG. 1A;

FIG. 1C shows a cross sectional view of the bottom section of the casing of FIG. 1A;

FIG. 2 is a detailed view of the electronic communications device of FIG. 1A when in use;

FIG. 3 is a schematic block diagram of the communications module as used in the electronic communications devices of FIG. 1A, FIG. 9A, FIG. 10, FIG. 11 and FIG. 12;

FIG. 4 shows a graphical user interface (GUI) displayed on a display of the electronic communications device of FIG. 1A, upon a business card being inserted into the device;

FIG. 5 shows an image of a business card displayed on the display of FIG. 4, upon the business card being scanned;

FIG. 6 shows the GUI of FIG. 4 being replaced by another GUI representing a keyboard;

FIG. 7 shows an image of a business card displayed on the display of the electronic communications device of FIG. 1A;

FIG. 8 shows an image of a business card retrieved from storage (or of a newly scanned business card) displayed on the display of the electronic communications device of FIG. 1A together with one or more speed keys;

FIG. 9A shows a detailed exploded view of an electronic communications device comprising a casing and a communications module, according to another embodiment of the present invention;

FIG. 9B shows a bottom view of a bottom section of the casing of FIG. 9A;

FIG. 10 is a detailed view of the electronic communications device of FIG. 9A when in use;

FIG. 11 is a detailed view of an electronic communications device according to still another embodiment of the present invention;

FIG. 12 is a detailed view of an electronic communications device according to still another embodiment of the present invention;

FIG. 13 shows the display of the electronic communications device of FIG. 12 in more detail;

FIG. 14 is another detailed view of the electronic communications device of FIG. 14; and

FIG. 15 is a detailed view of an electronic communications device according to still another embodiment of the present invention.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

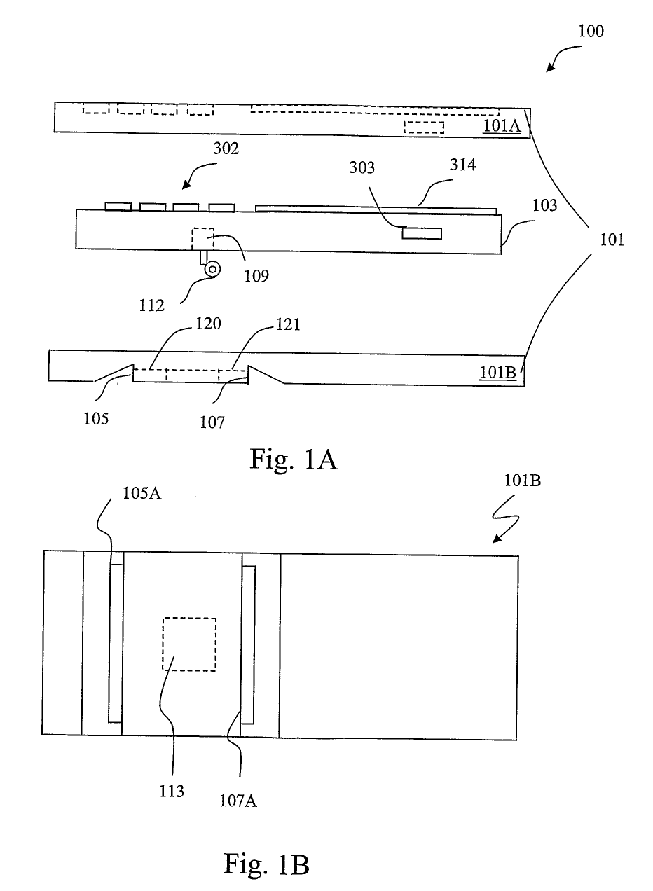

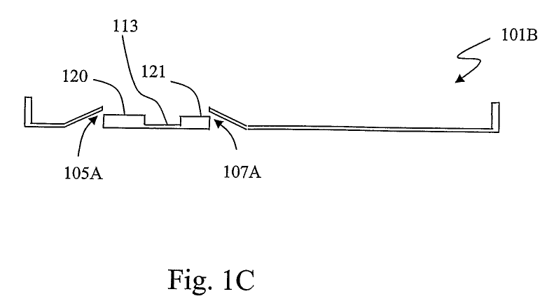

FIG. 1A shows an electronic communications device 100 comprising a casing 101 and a communications module 103. The casing 101 comprises a top section 101A and a bottom section 101B. The bottom section 101B of the casing 101 comprises access means in the form of an entry 105 (or receptacle) integrated with the bottom section 101B. The bottom section 101B also comprises an exit 107. As seen in FIG. 1B, the entry 105 comprises an opening 105A configured to accept a business card inserted into the electronic communications device 100 by a user. The exit 107 also comprises an opening 107A configured to deliver the inserted business card back to the user.

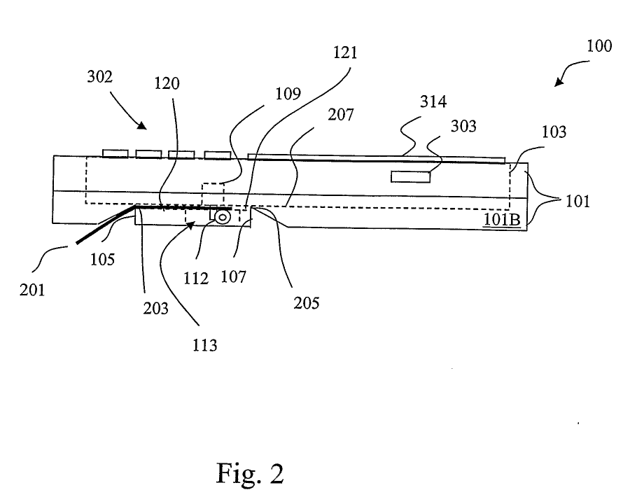

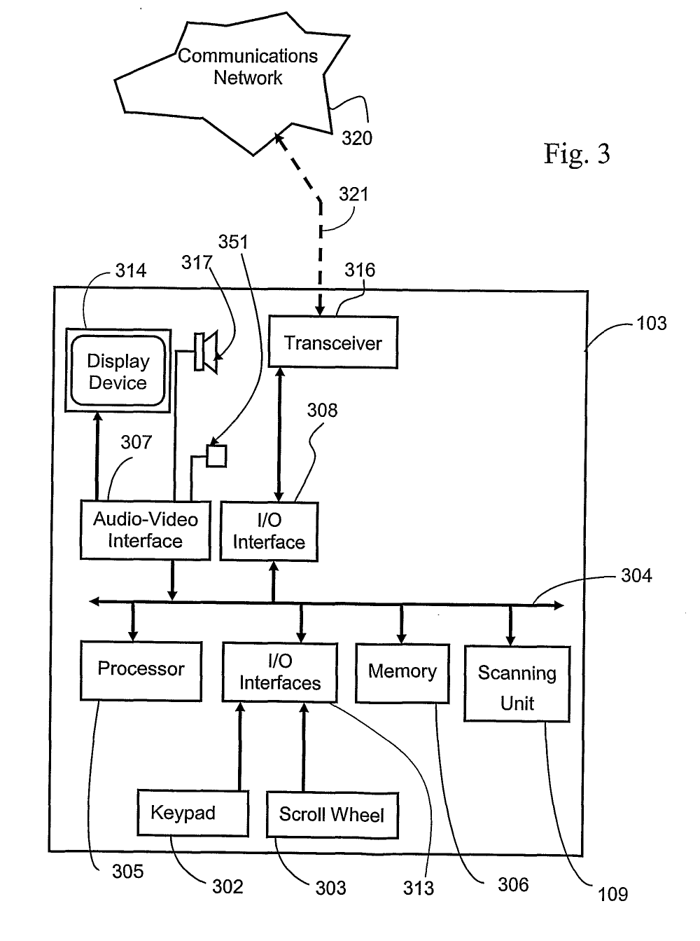

The communications module 103 comprises a display 314 (see FIG. 3), a keypad 302 (see FIG. 3), a scroll wheel 303 and a scanning unit 109. The arrangement of the scanning unit 109 forms a sheet fed business card scanner which serves to scan a business card 201 as seen in FIG. 2. The scanning unit 109 comprises an image sensor (not shown) (or image capture device) configured therein together with a light emitting diode (LED) (not shown). The image sensor comprises a charge-coupled device (CCD) array comprising a plurality of light sensitive diodes as known to those in the relevant art. The CCD array may be in any suitable form. For example, the CCD array may comprise a single line of light sensitive diodes or a plurality of lines of light sensitive diodes. The LED is used to illuminate the business card 201 when the business card 201 is being scanned. The scanning unit 109 is connected to a roller 112.

The communications module 103 may be mounted inside the casing 101, as shown in FIG. 2. When mounted inside the casing 101, the roller 112 sits in a section 113 of the bottom section 101B of the casing 101. The section 113 may be best seen in the cross sectional view of the bottom section of the casing 101B of FIG. 1C. As seen in FIG. 2, the opening 105A of the entry 105 is adjacent an opening 203 formed by a base 207 of the communications module 103 and a surface 120 of the casing 101B. Further, the opening 107A of the exit 107 is adjacent an exit opening 205 of the scanning unit 109 formed by the base 207 and another surface 121 of the casing 101B.

As seen in FIG. 3, the communications module 103 comprises the keypad 302, the display device 314, a microphone 351 and a loudspeaker 317. The display device 314 is preferably a touch screen device and is preferably larger than a conventional business card. However, the display device 314 may be of any suitable size. A transceiver device 316 may be used by the communications module 103 for communicating to and from a communications network 320 via a wireless communications channel 321. Alternatively, the communications module 103 may be hardwired to a communications network, for example, via a personal computer. The transceiver device 316 is preferably incorporated within the communications module 103. However, the transceiver device 316 may be configured outside the communications module 103.

The communications module 103 comprises the scanning unit 109. The communications module 103 also comprises at least one processor unit 305 and a memory unit 306. The memory unit 306 may be formed from semiconductor random access memory (RAM) and read only memory (ROM).

An audio-video interface 307 that couples to the display 314, the microphone 351 and loudspeaker 317 may be included. The module 103 may also comprise an interface 313 for the keypad 302 and the scroll wheel 303.

The components 109 and 305 to 316 of the communications module 103 typically communicate via an interconnected bus 304.

The processes described below may be implemented as software, such as one or more application programs resident in memory 306 and being controlled in their execution by the processor 305. In particular, steps of processes described herein may be effected by instructions in the software that are carried out within the communications module 103. The instructions may be formed as one or more code modules, each for performing one or more particular tasks. The software may also be divided into two separate parts, in which a first part and the corresponding code modules performs the described methods and a second part and the corresponding code modules manage user interfaces between the first part and the user. The software may be stored in a computer readable medium, including storage devices described below, for example. The software may be loaded into the ROM of the memory unit 306 from the computer readable medium, and then be executed by the processor 305. A computer readable medium having such software or computer program recorded on it is a computer program product.

Typically, the application programs discussed above are resident in the ROM of the memory unit 306 and are read and controlled in their execution by the processor 305. Intermediate storage of such programs and any data fetched from the network 320 may be accomplished using the memory unit 306. Computer readable media refers to any storage medium that participates in providing instructions and/or data to the module 103 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the electronic communications device 100.

The second part of the application programs and the corresponding code modules mentioned above may be executed to implement one or more graphical user interfaces (GUIs) to be rendered or otherwise represented upon the display 314. Through manipulation of the keypad 302, a user of the electronic communications device 100 and the application may manipulate the interface to provide controlling commands and/or input to the applications associated with the GUI(s).

Referring to FIGS. 1 and 2, a contact surface of the image sensor of the scanning unit 109 is preferably configured so as to prevent any undue interference of ambient light. The roller 112 may be mounted adjacent to the contact surface of the contact image sensor of the scanning unit 109.

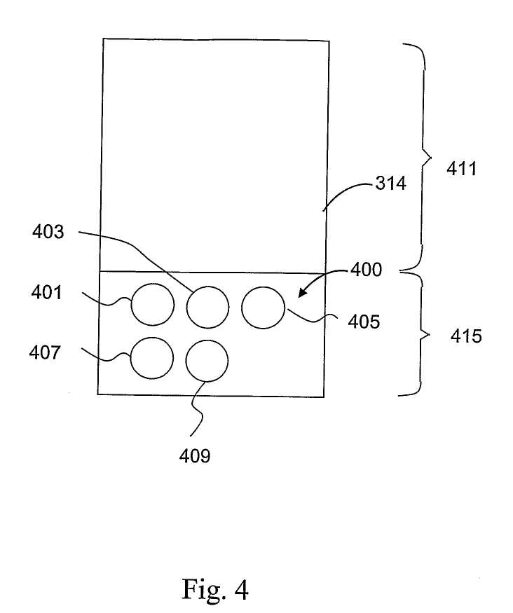

In order to scan the business card 201, the business card 201 is inserted into the entry opening 203 so as to sit between the scanning unit 109 and the roller 112. In response to the business card 201 being inserted, the processor 305 preferably displays a GUI 400 in a section 415 of the display 314 as seen in FIG. 4. The insertion of the business card 201 may be indicated to the processor 305 by a sensor (not shown) configured within the electronic communications device 100. Another section 411 of the display 314 is left blank. The GUI 400 comprises a ‘SCAN’ button 401, a ‘STORE’ button 403, a ‘BUSINESS’ button 405, a ‘PERSONAL’ button 407 and a ‘SORT’ button 409, as seen in FIG. 4, and may be used to control the scanning unit 109. The names of each of the buttons 401 to 409 may be displayed on the corresponding button of the GUI 400.

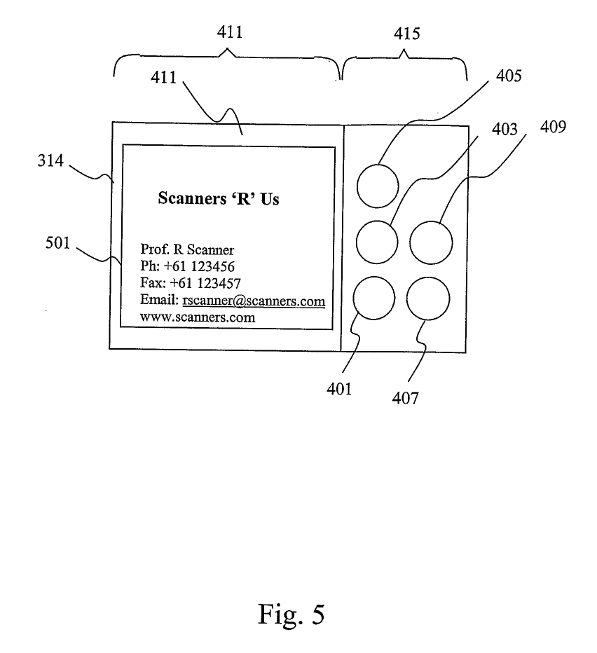

As described above, the display 314 is preferably a touch screen. The SCAN button 401, STORE button 403, a BUSINESS button 405, a PERSONAL button 407 and SORT button 409 may be selected by a user using a pointer in a conventional manner. Alternatively, a scroll wheel (not shown) may be configured on the electronic communications module 103 so as to communicate with the processor 305 in order to navigate information displayed on the display 314. In response to selection of the SCAN button 401 on the display 314, the roller 112 may be caused by the processor 305 to rotate so as to drive the business card 201 between the scanning unit 109 and the roller 112, as seen in FIG. 2. As the business card 201 is driven forward, the processor 305 causes the scanning unit 109 to scan the business card 201 to generate image data representing an image 501 (see FIG. 5) of the business card 201. The LED of the scanning unit 109 illuminates the business card 201 as the business card 201 if being scanned. The roller 112 drives the business card 201 so that the scanned business card 201 is delivered back to the user via the opening 107A of the exit 107. The image 501 of the business card 201 is also displayed on the display 314 in the section 411, as seen in FIG. 5. Then, in response to selection of the STORE button 403, the processor 305 may store the image data of the image 501 in an image file in the memory unit 306. The image data may also be compressed in order to allow for easier storing, transmitting and printing of the image 501.

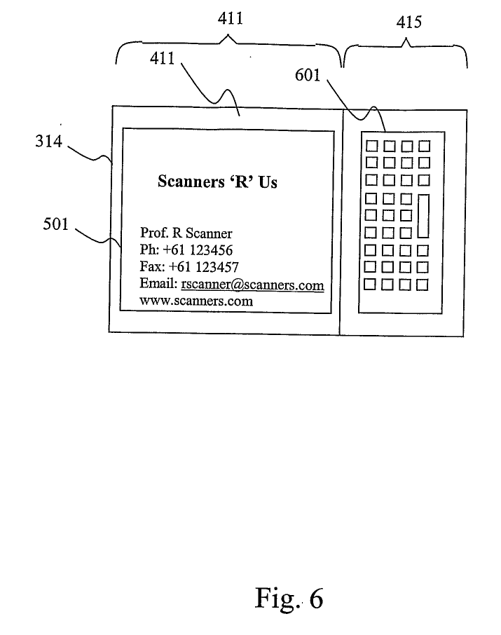

In response to selection of the BUSINESS button 405, the image 501 may be stored in a folder (titled ‘Business’) of a file directory structure application program being executed on the communications module 103. Further, in response to selection of the BUSINESS button 405, the GUI 400 may be replaced by another GUI 601 representing a keyboard as seen in FIG. 6. The keyboard GUI 601 may be a ‘Qwerty’ keyboard or a simplified keyboard (e.g., a Dvorak keyboard). The keyboard GUI 601 may then be used by the user to enter information about the business card 201 using a pointer in a conventional manner. The information entered using the GUI 601 may be stored in the memory unit 306 as a text file linked to the image file containing the image data of the image 501 generated by the scanning unit 109.

Similarly, in response to selection of the PERSONAL button 407, the image data of the image 501 representing the business card 201 may be stored in a folder titled ‘Personal’ of a file directory structure application program being executed on the module 103. Further, in response to selection of the PERSONAL button 407, the GUI 400 may be replaced by the GUI 601 representing the keyboard.

The image file comprising the image data representing the business card 201 may also be stored in a sub-folder of the Personal folder of the file directory, indicating the category of the business card 201. For example, the business card 201 may be categorised as Lawyer, Real Estate Agent or Motor Trader, depending on a type of business identified on the business card 201. This categorisation of the scanned business card 201 may be implemented by storing a variable together with the image file containing the image 501 representing the business card 201. For example, when the variable is equal to one (1), the business card 201 may be categorised as Lawyer, when the variable is equal to two (2), the business card 201 may be categorised as Real Estate Agent and when the variable is equal to three (3) the business card 201 may be categorised as Motor Trader. As will be described below, the categorisation of the business card 201 may be performed automatically by the processor 305 upon the business card 201 being scanned. Although, various categories (e.g., personal, business, lawyer, real estate agent and motor trader) have been described above, there are many other categories which may be applied to a scanned business card.

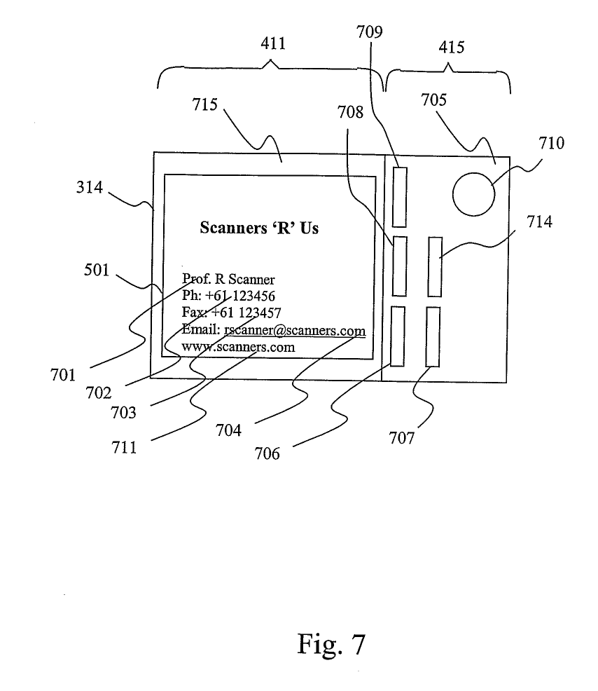

In one embodiment, in response to the SCAN button 401 being selected, an image 501 of the business card 201 may be displayed on the display 314 in the section 411, as seen in FIG. 7. A character recognition software application program resident in memory 306 and being controlled in its execution by the processor 305 may then be used to analyse the image 501 in order to determine information printed on the business card 201. The character recognition software application may be configured so as to recognise a plurality of character sets and languages enabling, the software application to determine information printed on the business card 201 in any required language. For example, as well as the Latin character sets, the character recognition software application may be configured to recognise the Arabic, Chinese, Cyrillic, Greek, Hebrew, Japanese and Korean character sets, as well as languages such as French, German, Indonesian, etc.

The information determined by the character recognition software application program may then be displayed in the section 415 of the display 314. In particular, a name 701, a telephone number 702, a facsimile number 703, an email address 704 and a Web address 711 may be determined by the processor 305 using character recognition and then be displayed in the section 415 at 706, 707, 708, 709 and 714, respectively. Then in response to selection of a STORE button 710, the name 701, telephone number 702, facsimile number 703, email address 704 and Web address 711 displayed in the section 415 may be stored in memory 306 with a link to an image file storing the image 501 representing the business card 201. Alternatively, the name 701, telephone number 702, facsimile number 703, email address 704 and Web address 711 displayed in the area 705 may be automatically stored in memory 306 together with the image file storing the image 501 for the business card 201, in response to the SCAN button 401 being selected, without the STORE button 710 being selected.

Further, the character recognition software may use a mapping function to automatically match the information on the business card 201 to an array stored in memory 306 in order to determine the category of the business card 201. For example, if the processor 305 recognises the word ‘Solicitor’ printed on the business card 201, then the processor 305 may set the category flag associated with the image file to one (1) for the business card 201 and store the image file in a folder titled ‘Lawyers’. Alternatively, if the processor 305 recognises the words ‘Real Estate Agent’ printed on the business card 201, then the processor 305 may set the category flag associated with the image file to two (2) for the business card 201 and store the image file in a folder titled ‘Real Estate Agents’. This categorisation may be performed in response to the SORT button 406 of the GUI 400 being selected. Alternatively, this categorisation may be performed in response to the SCAN button 401 of the GUI 400 being selected.

In one embodiment, in response to the SORT button 406 being selected, the processor 305 may access all business card image files stored in memory 306 and use a category variable associated with each of the image files to determine the category of the business card 201 represented by the image file. The processor 305 may then store each of the image files in an appropriate folder (e.g., Lawyer, Real Estate Agent, Motor Trader etc) depending on the category of each of the business cards. Such an operation may be performed, for example, if the user wishes to update their categories.

In one embodiment, the name 701, telephone number 702, facsimile number 703, email address 704 and Web address 711 displayed in the section 415 of the display 314 at 706, 707, 708, 709 and 714 may be selected by the user (e.g., using a pointer or the scroll wheel 303) in order to perform a particular action. For example, in the instance that the electronic communications device 100 has a telephone function, upon selection of the telephone number 702, the processor 305 may dial the telephone number in order to connect to the telephone number 702 over the communications network 320. As another example, upon selection of the email address 708, the processor 305 may execute an email application resident in the memory 306 in order to allow the user to draft an email to the recipient represented by the email address 708. As a still further example, upon selection of the Web address 711, the processor 305 may execute an Internet browser application resident in the memory 306 in order to connect the processor 305 to a Web page represented by the Web address 711, via the communications network 320.

The image 501 of the business card 201, name 701, telephone number 702, facsimile number 703, email address 704 and Web address 711 stored in memory 306, may be subsequently searched on and retrieved using the electronic communications device 100. For example, a list of identifiers representing the scanned business cards stored in memory 306 may be displayed on the display 314. This list of identifiers may be navigated and selected using the scroll wheel 303. Typically, the scroll wheel 303 is pressed when the user wishes to select a particular identifier. The identifiers may be listed on the display 314 under a title representing the category of the identifiers in the list.

The image 501 of the business card 201 and the associated information stored in memory 306 may be retrieved based on the category of the business card 201. For example, by typing the keyword ‘Lawyer’ into the electronic communications device 100 using the keypad 302 and pressing the scroll wheel 303, the processor 305 may search the memory 306 and determine all of the image files containing image data for scanned business cards stored in the memory 306 with a variable representing the Lawyer category. These scanned business cards may then be listed on the display 314 and be selected using the scroll wheel 303 as described above. Alternatively, a keyword may be selected from a menu such as a drop down menu of keywords. For example, a drop down menu list of categories may be presented to the user.

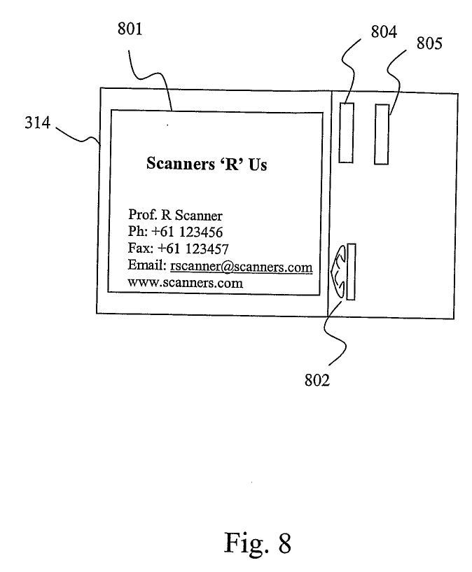

In one embodiment, an image 801 of a retrieved business card 201 (or a newly scanned business card), may be displayed on the display 314 together with one or more speed keys 802, 804 and 805, as seen in FIG. 8. In this instance, the user may merely select one of the speed keys in order for the processor 305 to perform the appropriate action. For example, if the user selects the speed key 802 representing a telephone number, the processor 305 may be configured to determine the telephone number 702 printed on the business card 201 using a character recognition software application program and then dial the telephone number in order to connect to the telephone number over the communications network 320. Similarly, upon selection of an email icon 804, the processor 305 may determine the email address 704 printed on the business card 201 and execute the email application resident in the memory 306 in order to allow the user to draft an email to the recipient represented by the email address 704. As a still further example, upon selection of the Web address icon 805, the processor 305 may determine the Web address 711 printed on the business card 201 and execute an Internet browser application resident in the memory 306 in order to connect the processor 305 to a Web page represented by the Web address, via the communications network 320.

The communications module 103 may also include a global positioning system (GPS) transceiver (not shown) configured therein. In this instance, the processor 305 may use the GPS transceiver to determine in which country and/or area the electronic communications device 100 is being used. Upon determining the country and/or area, the processor 305 may download information and/or software applications to the memory 306 over the communications network 320 according to the country and/or area.

In one embodiment, the communications module 103 may also include a navigational software application program resident in the memory 306 and being controlled in its execution by the processor 305. In this instance, the character recognition software application program may analyse an image of the business card 201 (e.g., the image 501) in order to determine the information (e.g., a business address) printed on the business card 201. The processor 305 may then use the information (e.g., the business address) printed on the business card 201 to determine the location of the business detailed on the business card 201. The location of the business may then be compared to the location of the communications device 100 as determined using the GPS transceiver. The processor 305 may then execute the navigational software application program and provide directions to the user of the electronic communications device 100 on how to get to the location of the business.

Images of scanned business cards generated using the electronic communications device 100 may also be attached to an email drafted using the electronic communications device 100. The email with the attached image of the business card may be transmitted over the communications network 320. An electronic business card (not shown) may also be generated using the electronic communications device 100 and may be stored in memory 306. This electronic business card may also be attached to an email drafted using the electronic communications device 100 and be transmitted over the communications network 320.

The entry 105 configured to accept the business card 201 inserted into the electronic communications device 100 and the exit 107 configured to deliver the inserted business card 201, may be positioned at any suitable position on the casing 101. For example, the entry 105 and exit 107 may be configured on the top section 101A of the electronic communications device 100. In this instance, the scanning unit 109 and roller 112 may also be positioned within the communications module 103 or external to the communications module 103, so as to sit adjacent to the entry 105 and exit 107 on the top section 101A.

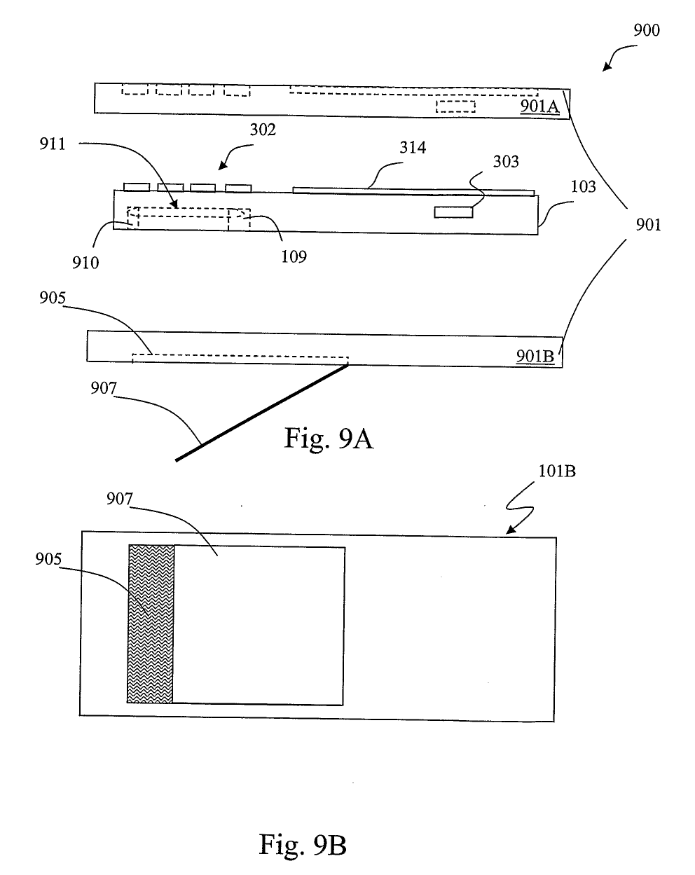

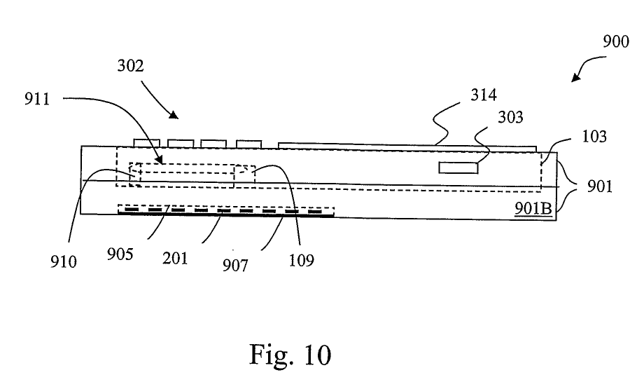

In still another embodiment, device 100 may be configured with the entry 105 without the exit 107. The entry 105 in this embodiment will also act as the exit. In this instance, in order to scan the business card 201, the business card 201 is inserted into the entry opening 203 so as to sit between the scanning unit 109 and the roller 112. The roller may be caused by the processor 305 to rotate so as to drive the business card 201 into the casing 101 and over the scanning unit 109. Once the card has been scanned, the roller 112 may then be caused to rotate in the reverse direction to deliver the inserted business card back to the user. In the embodiments described above, the scanning unit 109 integrated with the electronic communications module 100 was stationary and arranged as a sheet fed business card scanner. FIG. 9 shows an electronic communications device 900 comprising a casing 901 and the communications module 103, according to another embodiment of the present invention. Again, the communications module 103 may be mounted inside the casing 901, as shown in FIG. 10. The casing 901 comprises a top section 901A and a bottom section 901B. The bottom section 901B of the casing 101 comprises an access means in the form of a window 905 integrated with the bottom section 901B. The bottom section 901B also comprises a lid 907 configured to cover the window 905 when the lid 907 is in a closed position. The lid 907 is shown in an open position in FIGS. 9A and 9B. As seen in FIG. 9B, the window 905 is formed of a transparent perspex, glass or similar material. The window 906 is preferably the same size as a conventional business card and is configured in the casing 901B to accept a business card placed against the window 905.

In the embodiment of FIGS. 9 and 10, the scanning unit 109 is connected to a small stepper motor 910 via a belt 911. In order to scan the business card 201, the business card 201 is placed against the window 905 and the lid 907 is closed, as seen in FIG. 10, so as to prevent any undue interference of ambient light. In response to the lid 907 being opened and closed, the processor 305 preferably displays the GUI 400 in a section 415 of the display 314 as described above with reference to FIG. 4. Again, another section 411 of the display 314 is left blank. In response to selection of the SCAN button 401 on the display 314, the stepper motor 910 drives the belt 911 to move the scanning unit 109 slowly across the business card 201 in order to scan the business card 201 and generate image data representing the business card 1001, as described above. Again, the LED of the scanning unit 109 illuminates the business card 201 as the business card 201 is being scanned. Again, an image 501 of the business card 201 is also displayed on the display 314 in the section 411, as seen in FIG. 5 and the image data representing the business card 201 may be stored and processed as described above with reference to FIG. 1A to 8. The arrangement of the window 905 and the scanning unit 109 forms a flat bed scanner.

In another embodiment, the window 905 and lid 907 of the embodiment of FIGS. 9A and 9B may be positioned at any suitable position on the casing 901. For example, the window 905 and lid 907 may be configured on the top section 901A of the electronic communications device 100 in place of the keypad 302. In this instance, the scanning unit 109, motor 910 and belt 911 may also be positioned in the communications module 103 or external to the communications module 103, adjacent the window 905 and lid 907 on the top section 101A.

In still another embodiment, the electronic communications device 900 may comprise the window 905 without the lid 907. In this instance, the business card 201 to be scanned may be held against the window 905 by a user, while an image of the business card is being generated. Alternatively, a clip (not shown) may be arranged adjacent to the window 905 so that the clip secures the business card 201 to be scanned (against the window 905), while an image of the business card is being generated. Such a clip may also include a sensor means (e.g., a pressure sensor, a capacitive sensor, a radio frequency (RF) sensor or the like). The sensor means may detect the card when the card is placed under the sensor. Upon detection of the card, the processor 305 may initiate the scanning of the card. The user may also cup their hand over the display 314, while an image of the business card is being generated, in order to prevent any undue interference of ambient light.

In still another embodiment, the scanning unit 109 of the electronic communications device 900 may in the form of an image capture device such as a charge-coupled device (CCD) or a complementary metal-oxide semiconductor (CMOS) sensor or the like, similar to those used in digital cameras. In this instance, when the business card 201 is placed 201 against the window 905, the image capture device captures an image of the business card 201 which may be then processed as described above.

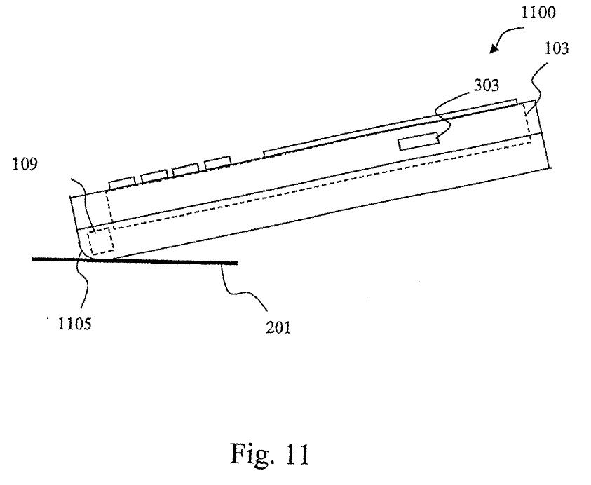

In accordance with another embodiment, an electronic communications module 1100, as seen in FIG. 11, may be used as a handheld business card scanner. The electronic communications module 1100 comprises a casing 1101 with the communications module 103 mounted therein. The casing 1101 comprises a top section 1101A and a bottom section 1101B. The bottom section 1101B of the casing 101 comprises an access means in the form of a window 1105 integrated with the bottom section 1101B. Again, the window 1105 is formed of a transparent perspex, glass or similar material. The window 1105 may have a curved edge as seen in FIG. 11.

In the embodiment of FIG. 11, the scanning unit 109 is located and fixed externally to the communications module 103 adjacent the window 1105. The communications module 103 may be connected to the scanning unit 109, as seen in FIG. 11, using any suitable connection means such as a bus, a cable or the like, so that the communications module 103 can send control signals and data to the scanning unit 109 and receive data back from the scanning unit 109.

In response to a predetermined key of the keypad 302 being selected by the user, the processor 305 preferably displays the GUI 400 in the section 415 of the display 314 as described above with reference to FIG. 4. Again, another section 411 of the display 314 is left blank. Alternatively, the GUI 400 may be displayed in response to some other action by the user (e.g., pressing the scroll wheel 303).

In order to scan the business card 201, the business card 201 is placed against a flat surface and the window 1105 of the bottom section 1101B is placed against the business card 201 as seen in FIG. 11. The SCAN button 401 on the display 314 may then be selected and the scanning unit 109 may be moved across the business card 201 in order to scan the business card 201 and generate image data representing the business card 201. Again, the LED of the scanning unit 109 illuminates the business card 201 as the business card 201 is being scanned. An image 501 of the business card 201 is also displayed on the display 314 in the section 411, as seen in FIG. 5, and the image data of the image representing the business card 201 may be stored and processed as described above with reference to FIG. 1A to 8.

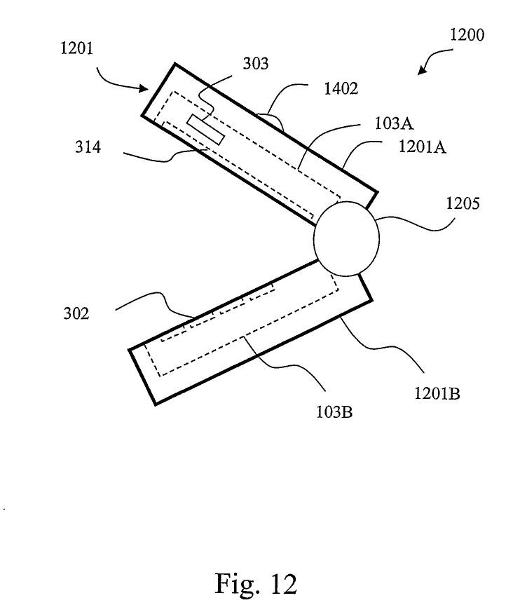

FIG. 12 shows an electronic communications device 1200 comprising a casing 1201 with the communications module 103 mounted inside the casing 1201, according to another embodiment of the present invention. The casing 1201 comprises a top section 1201A and a bottom section 1201B. The top section 1201A and the bottom section 1201B are pivotally connected by a pivot 1205. Similarly, in the embodiment of FIG. 12, the communications module 103 also comprises a top section 103A comprising the display 314 and a bottom section 103B comprising the keypad 302. The pivot 1205 may be configured using any suitable pivoting means. The pivoting means preferably comprises a flexible bus (e.g., flat multi-strand wire) connecting the top section 103A and bottom section 103B of the communications module 103. The flexible bus allows signals to be sent between the components 302 to 316 of the communications module 103. The pivot 1205 allows the top section 1201A to fold onto the bottom section 1201 in a similar manner to conventional ‘flip’ mobile telephones.

In the embodiment of FIG. 12, the display 314 is comprised of a plurality of light emitting diodes (LEDs) 1301A, 1301B, 1301C etc., interleaved with a plurality of light sensitive diodes 1302A, 1302B, 1302C etc. Accordingly, the LEDs 1301A, 1301B, 1301C etc form a display means for displaying images and the light sensitive diodes 1302A, 1302B, 1302C etc form a CCD array. In this instance, the CCD array may be referred to as the scanning unit for scanning the business card 201 and generating image data representing the business card 201. The display means comprising the LEDs 1301A to 1301C may be said to be interleaved with the scanning unit comprising the light sensitive diodes 1302A to 1302C.

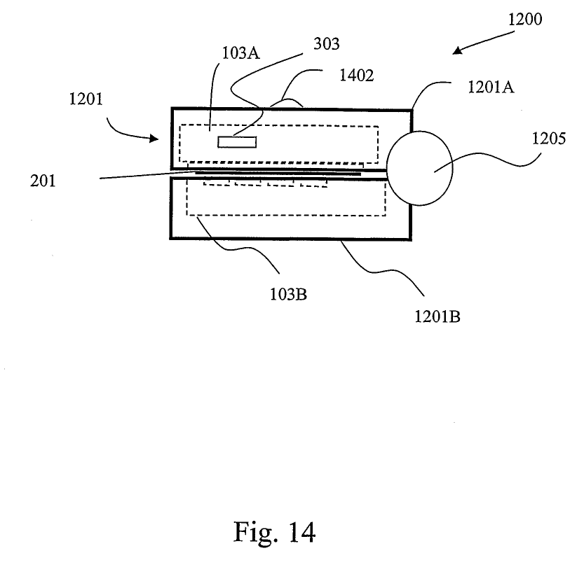

In order to scan the business card 201, the business card 201 is placed against the display 314 and the top section 1201A is folded onto the bottom section 1201B, as seen in FIG. 14, so as to prevent any undue interference of ambient light. A button 1402 positioned in any suitable position on the casing 1201 may then be selected by a user. Alternatively, the scroll wheel 303 may be pressed. In response to the button 1402 being selected or the scroll wheel 303 being pressed, the processor 305 causes the LEDs 1301A, 1301B, 1301C, 1301D etc to display a white image which is used to illuminate the business card 201 while the light sensitive diodes 1302A, 1302B, 1302C etc generate image data representing the business card 201.

To generate the image data representing the business card 201, the light sensitive diodes 1302A, 1302B, 1302C detect a portion of the light (as generated by LEDs generating the white image) which is reflected from the business card 201. Each of the light sensitive diodes 1302A, 1302B, 1302C etc is preferably shielded from light generated by the LEDs 1301A, 1301B, 1301C, 1301D surrounding the corresponding light sensitive diodes 1302A, 1302B, 1302C etc, by surrounding each of the light sensitive diodes 1302A, 1302B, 1302C with a non-reflective shielding material. This reduces any interference on the light sensitive diodes 1302A, 1302B, 1302C by light generated by the LEDs 1301A, 1301B, 1301C, 1301D, and improves the quality of the image generated by the light sensitive diodes 1302A, 1302B, 1302C. The image data representing the business card 201 generated by the light sensitive diodes 1302A, 1302B, 1302C may be stored in a memory 306 of the electronic communications device 1400 and may be processed as described above with reference to FIG. 1A to 8.

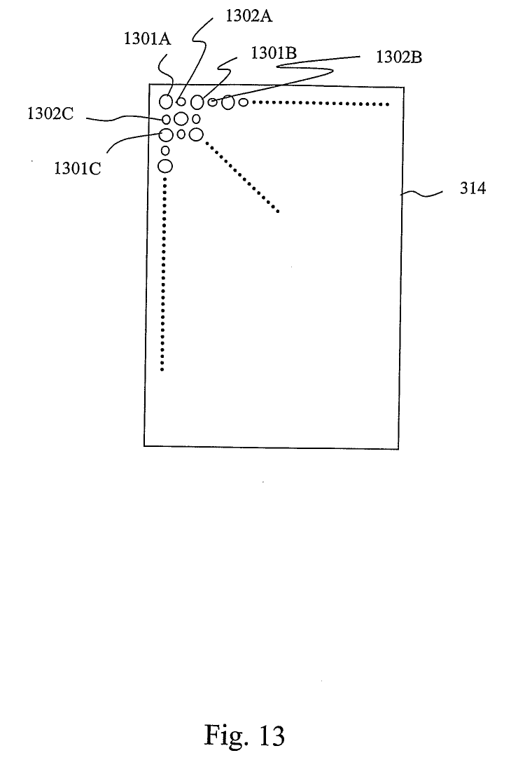

The display 314 of FIG. 13 comprising the interleaved LEDs 1301A, 1301B, 1301C, etc and the light sensitive diodes 1302A, 1302B, 1302C etc may be used with any configuration of electronic communications device including the device 100, the device 900 or even the device 1100 described above, for example. For these devices 100, 900 and 1100, the business card 201 to be scanned may be placed against the display 314 and a user's hand may be cupped over the display 314, while an image of the business card is being generated, in order to prevent any undue interference of ambient light. Alternatively, the display 314 may be covered in any other suitable manner (e.g., a lid covering the display 314) to prevent any undue interference of ambient light while an image of the business card 201 is being captured.

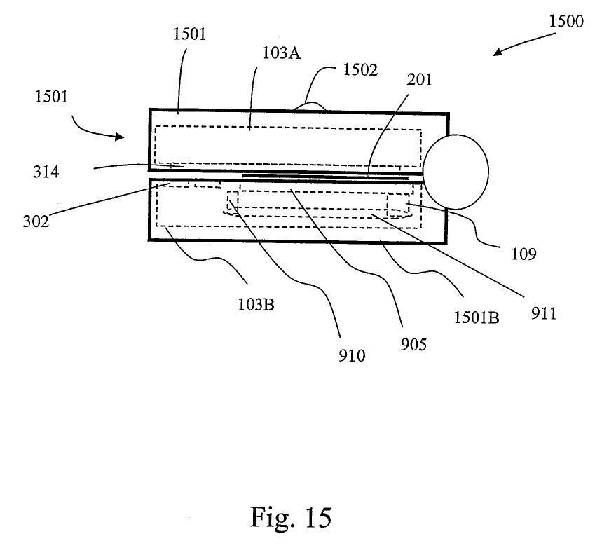

In still another embodiment, as seen in FIG. 15, an electronic communications device 1500 may be configured in a similar manner to the device 1200. In the embodiment of FIG. 15, a bottom section 103B of the communications module 103 of the electronic communications device 1500 of FIG. 15 may comprise the stepper motor 910, belt 911 and scanning unit 109 configured next to the keypad 302. In this instance, the window 905 may also be positioned next to the keypad 302 on a bottom section 103B of the electronic communications module 103. Alternatively, the keypad 302 on the bottom section 103B may be replaced by the window 905. In order to scan the business card 201 using the electronic communications device 1500 the business card 201 may be placed against the window 905 on the bottom section 103B of the electronic communications device 1500. A top section 1201A of a casing 1501 within which the communications module 103 is mounted may then be folded onto a bottom section 1501B, in a similar manner to the electronic communications device 1200 of FIG. 14, so as to prevent any undue interference of ambient light. A button 1502 may then be selected by a user. In response to selection of the button 1502, the processor 305 may cause the stepper motor 910 to drive the belt 911 to move the scanning unit 109 slowly across the business card 201 in order to scan the business card 201 and generate image data representing the business card 1001, as described above.

In still another embodiment, the window 905 of the electronic communications device 900 may be replaced with a CCD array (i.e., a plurality of light sensitive diodes) together an LED. In this instance, in order to scan the business card 201, the business card 201 is placed against the CCD array and the lid 907 is closed, in a similar manner to the electronic device 900 of FIG. 10, so as to prevent any undue interference of ambient light. The LED may be used to illuminate the business card 201 as the business card 201 is being scanned.

In still another embodiment, the window 905 of the electronic communications device 900 may be replaced with the display 314 of FIG. 13 comprising the interleaved LEDs 1301A, 1301B, 1301C, etc and the light sensitive diodes 1302A, 1302B, 1302C etc. In this instance, in order to scan the business card 201, the business card 201 is placed against the display 314 and the lid 907 is closed, in a similar manner to the electronic communications device 900 of FIG. 10, so as to prevent any undue interference of ambient light. In response to the button 1402 being selected or the scroll wheel 303 being pressed, the processor 305 causes the LEDs 1301A, 1301B, 1301C, 1301D etc to display a white image which is used to illuminate the business card 201 while the light sensitive diodes 1302A, 1302B, 1302C etc generate image data representing the business card 201.

In still another embodiment, the display 314 of each of the electronic communications devices 100, 900, 1100, 1200 and 1500 may comprise a write overlay or the like. Such a write overlay allows the user to use a stylus in order to write on the display 314. In such an embodiment, when the scanning unit (e.g., 109) generates an image of the business card (e.g., 201) and the image is displayed on the display 314, the user may use the stylus to write on the display 314. The processor 305 is configured to recognise anything that is written on the write overlay, convert the writing into a digital representation of the writing and display the digital representation of the writing on the display 314 over the image of the business card. For example, the user may record an appointment by writing “Monday, 5:00 pm” on the display 314. Subsequently, when the image of the business card is stored in an image file in the memory of the communications device, the processor 305 also stores the digital representation of the writing that the user has written on the display 314 in the image file together with the image of the business card. When the stored image file containing the image of the business card is again subsequently displayed by the user, the digital representation of the writing is again displayed over the image of the business card.

The electronic communications devices 100, 900, 1100, 1200 and 1500 described above may be in the form of a mobile telephone, a personal digital assistant (PDA), a Blackberry™ or similar device. The electronic communications devices 100, 900, 1100, 1200 and 1500 may also comprise other capabilities found in conventional electronic communications devices such as a camera (e.g., video or still), universal serial bus (USB) ports and the like, and may be used to execute MP3 files, for example. The electronic communications devices 100, 900, 1100, 1200 and 1500 may also comprise many other graphical user interfaces other than those described above. For example, the graphical user interfaces may comprise a calendar and a clock (e.g., local and international clock). The graphical user interfaces may also include a file directory structure for the file directory application program being executed on the communications module 103. One of the graphical user interfaces may display folders such as My Documents, My Videos, My Pictures and the like as known to those skilled in the relevant art.

The embodiments described above reduce or eliminate any undue interference of ambient light on an image being generated and enable the size of documents within captured images to be consistent. This enables the user to generate images of consistent quality.

### INDUSTRIAL APPLICABILITY

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive. For example, the display 314 comprised of the plurality of light emitting diodes (LEDs) 1301A, 1301B, 1301C etc., interleaved with the plurality of light sensitive diodes 1302A, 1302B, 1302C etc, may be used in any other computer device. For example, the display 314 may be used with a personal computer including an IBM-PC's and compatibles, Sun Sparcstations, Apple Mac™ or alike computer systems evolved therefrom. In this instance, in order to scan a document, the document may be placed against the display 314. The processor of the computer may then be configured to cause the LEDs 1301A, 1301B, 1301C, 1301D etc to display a white image which is used to illuminate the document while the light sensitive diodes 1302A, 1302B, 1302C etc generate image data representing the document. The generated image data representing the document may be stored in a memory of the computer and may be processed in a conventional manner.

In the context of this specification, the word “comprising” means “including principally but not necessarily solely” or “having” or “including”, and not “consisting only of”. Variations of the word “comprising”, such as “comprise” and “comprises” have correspondingly varied meanings.

1-27. (canceled)

28. A communication method comprising the steps of:
generating an image of at least a portion of a business card, using an electronic communications device;
analyzing the image in order to determine information printed on the business card; and
displaying, on a display of the device, the information determined by the analysis, wherein, upon selection of the displayed portion of information, the device is configured to perform one or more of voice, text or graphics wireless communications.

29. The method according to claim 28, further comprising the step of displaying the image of the business card on the display together with the displayed portion of information.

30. The method according to any one of claims 28 and 29, wherein the portion of information is a Web address.

31. The method according to claim 30, wherein the device is connected, via a communications network, to a Web site represented by the Web address upon selection of the displayed portion of information.

32. The method according to any one of claims 28 to 31, wherein the portion of information is a telephone number.

33. The method according to any one of claims 28 to 32, wherein the device is connected, via a communications network, to a telephone represented by the telephone number upon selection of the displayed portion of information.

34. The method according to any one of claims 28 to 33, wherein the portion of information is an email address.

35. The method according to claim 34, wherein the device is configured to send an email to a server represented by an email address printed on the business card upon selection of the displayed portion of information.

36. The method according to claim 28, wherein the device is configured to store the information determined by the analysis, in a memory of the device.

37. The method according to any one of claims 28 to 36, wherein the display comprises a touch screen.

38. The method according to any one of claims 28 to 37, wherein the device is a mobile telephone.

39. The method according to any one of claims 28 to 38, wherein the device is a personal digital assistant.

40. The method according to any one of claims 28 to 39, wherein the image is analyzed using character recognition software in order to determine information printed on the business card.

41. An electronic communication device for use in voice, text and graphics wireless communications over a communications network, said device comprising:
means for generating an image of at least a portion of a business card, using the electronic communications device;
means for analyzing the image in order to determine information printed on the business card; and
means for displaying, on a display of the device, the information determined by the analysis, wherein, upon selection of the displayed portion of information, the device is configured to perform at least one of voice, text or graphics wireless communications.

42. An electronics communication device for use in voice, text and graphics wireless communications over a communications network, said device comprising:
a memory for storing data and a computer program; and
a processor coupled to said memory executing said computer program, said computer program comprising instructions for:
generating an image of at least a portion of a business card, using the electronic communications device;
analyzing the image in order to determine information printed on the business card; and
displaying, on a display of the device, the information determined by the analysis, wherein, upon selection of the displayed portion of information, the device is configured to perform at least one of voice, text or graphics wireless communications.

43. A computer readable storage medium having a computer program recorded therein, the program being executable by a computer apparatus to make the computer perform a communication method, said program comprising:
code for generating an image of at least a portion of a business card, using an electronic communications device;
code for analyzing the image in order to determine information printed on the business card; and
code for displaying, on a display of the device, the information determined by the analysis, wherein, upon selection of the displayed portion of information, the device is configured to perform at least one of voice, text or graphics wireless communications.
